(19) United States
(12) Patent Application Publication
(10) Pub. No.: US 2019/0275646 A1
(43) Pub. Date: Sep. 12, 2019

(54) Engagement structure for tool

(71) Applicant: Ben Wen LIU, Taichung City (TW)

(72) Inventor: Ben Wen LIU, Taichung City (TW)

(21) Appl. No.: 15/917,861

(22) Filed: Mar. 12, 2018

(51) Int. Cl. B25B 13/48

(52) U.S. Cl. CPC B25B 13/481; B25B 13/461

(57) ABSTRACT

An engagement structure for a tool contains: a drive member. The drive member includes an accommodation orifice defined in the drive member, a hexagonal tooth portion formed around the accommodation orifice, and six arcuately concave sections respectively arranged on six sides of the hexagonal tooth portion. Each of the six arcuately concave sections is arranged on a center of each of the six sides of the hexagonal tooth portion. The drive member further includes multiple bevel rims, any two spaced of the multiple bevel rims respectively extend from two sides of each arcuately concave sections, and any adjacent of the multiple bevel rims connect, wherein an inclined angle each of the multiple bevel rims is 2 degrees.

### FIELD OF THE INVENTION

The present invention relates to an engagement structure for a tool in which the multiple bevel rims of the hexagonal tooth portion engage with and rotate a peripheral side of the hexagonal object or the non-hexagonal object easily.

### BACKGROUND OF THE INVENTION

With reference to FIGS. 1-3, a conventional engagement structure for a tool contains a drive member 10 including an accommodation orifice 11 defined in the drive member 10, a hexagonal tooth portion 12 formed around the accommodation orifice 11, such that a hexagonal object 12 is accommodated in the accommodation orifice 11 and is engaged and rotated by the hexagonal tooth portion 12. However, the hexagonal tooth portion 12 cannot engage and rotate a non-hexagonal object 14.

Referring to FIGS. 4-7, another engagement structure for a tool contains a drive member 20 including an accommodation orifice 25 defined in the drive member 20, six tooth portions 21 formed around the accommodation orifice 25, wherein multiple first corners 22 or multiple second corners 23 formed on canters of the six tooth portions 21 individually, and each first corner 22 is adjacent to each second corner 23, and a plan segment 24 extends from a first end of each first corner 22 or each second corner 23, and a concave segment 26 formed on a second end of each first corner 22 or each second corner 23, such that the drive member 20 rotates a hexagonal object 27 or a non-hexagonal object 28 by using the plan segment 24 of each first corner 22 or each second corner 23.

Nevertheless, the drive member 20 cannot engage and rotate the hexagonal object 27 or a non-hexagonal object 28 effectively.

As shown in FIG. 5, when the drive member 20 rotates idly, an idle angle of the drive member 20 is more than 10 degrees, so it cannot be operated smoothly in a limited space.

The present invention has arisen to mitigate and/or obviate the afore-described disadvantages.

### SUMMARY OF THE INVENTION

The primary aspect of the present invention is to provide an engagement structure for a tool in which the multiple bevel rims of the hexagonal tooth portion engage with and rotate a peripheral side of the hexagonal object or the non-hexagonal object easily.

Another aspect of the present invention is to provide an engagement structure for a tool which is applicable for is any one of a ratchet wrench, a socket, and an open end wrench.

To obtain above-mentioned aspect, an engagement structure for a tool provided by the present invention contains: a drive member.

The drive member includes an accommodation orifice defined in the drive member, a hexagonal tooth portion formed around the accommodation orifice, and six arcuately concave sections respectively arranged on six sides of the hexagonal tooth portion.

Each of the six arcuately concave sections is arranged on a center of each of the six sides of the hexagonal tooth portion.

The drive member further includes multiple bevel rims, any two spaced of the multiple bevel rims respectively extend from two sides of each arcuately concave sections, and any adjacent of the multiple bevel rims connect, wherein an inclined angle each of the multiple bevel rims is 2 degrees.

Preferably, the multiple bevel rims of the hexagonal tooth portion engage with and rotate a peripheral side of the hexagonal object or the non-hexagonal object.

Preferably, an idle angle of the hexagonal tooth portion 32 as revolving the drive member 30 is less than 5 degrees

Preferably, the tool is any one of a ratchet wrench, a socket, and an open end wrench.

Preferably, an angle between each bevel rim and a plane is within 2 degrees to 5 degrees.

### BRIEF DESCRIPTION OF THE DRAWINGS

FIG. 1 is a cross sectional view showing the assembly of a conventional engagement structure for a tool.

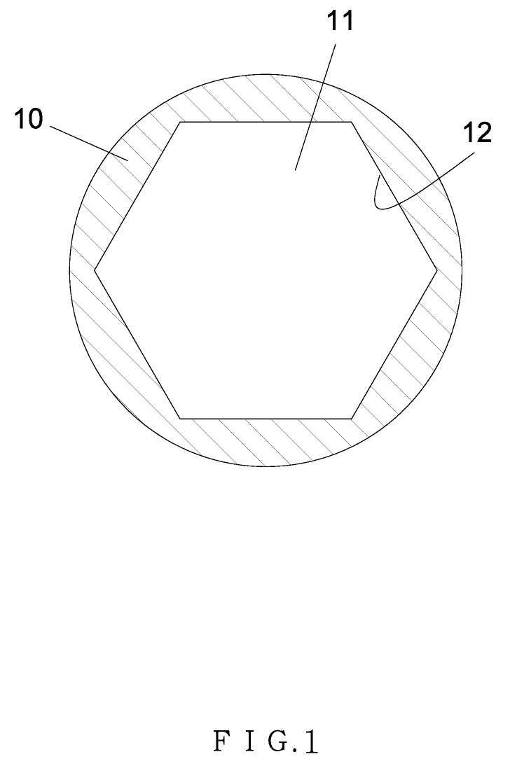

FIG. 2 is a cross sectional view showing the operation of the conventional engagement structure for the tool.

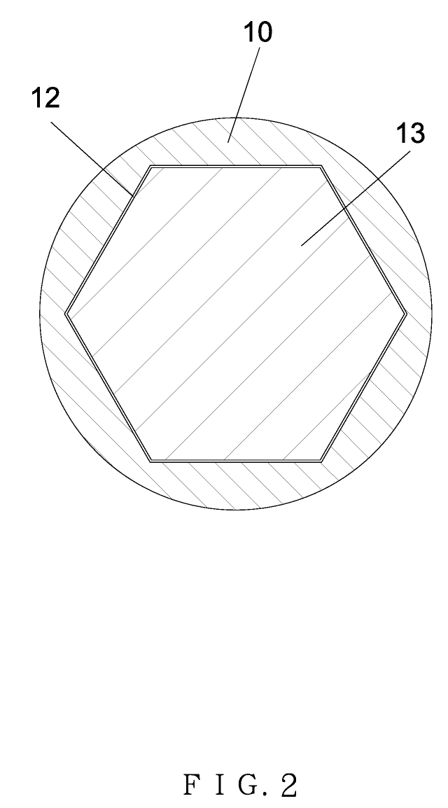

FIG. 3 is another cross sectional view showing the operation of the conventional engagement structure for the tool.

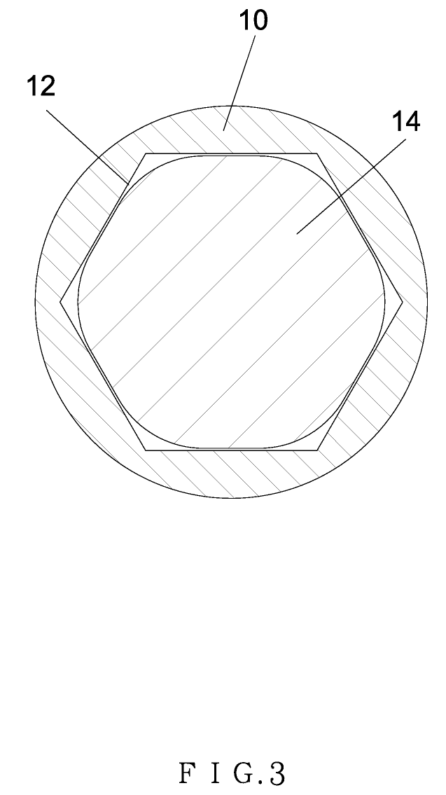

FIG. 4 is a cross sectional view showing the assembly of another conventional engagement structure for a tool.

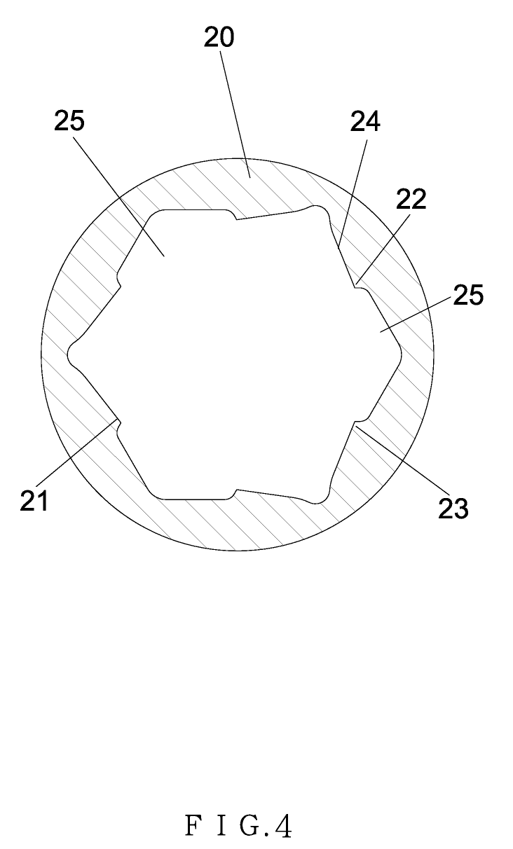

FIG. 5 is a cross sectional view showing the operation of another conventional engagement structure for a tool.

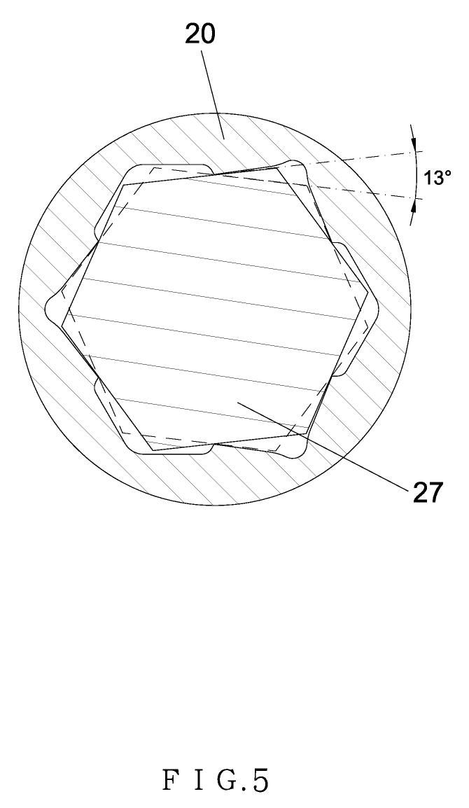

FIG. 6 is another cross sectional view showing the operation of another conventional engagement structure for a tool.

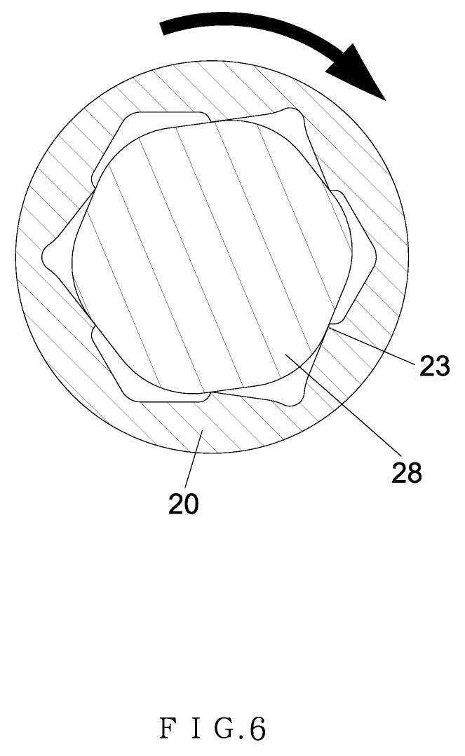

FIG. 7 is also another cross sectional view showing the operation of another conventional engagement structure for a tool.

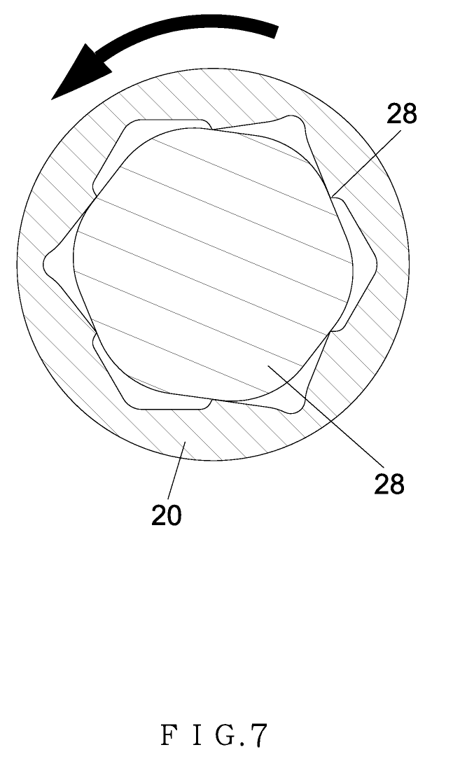

FIG. 8 is a cross sectional view showing the assembly of an engagement structure for a tool according to a preferred embodiment of the present invention.

FIG. 9 is a cross sectional view showing the assembly of a part of the engagement structure for the tool according to the preferred embodiment of the present invention.

FIG. 10 is a cross sectional view showing the operation of the engagement structure for the tool according to the preferred embodiment of the present invention.

FIG. 11 is another cross sectional view showing the operation of the engagement structure for the tool according to the preferred embodiment of the present invention.

FIG. 12 is also another cross sectional view showing the operation of the engagement structure for the tool according to the preferred embodiment of the present invention.

FIG. 13 is still another cross sectional view showing the operation of the engagement structure for the tool according to the preferred embodiment of the present invention.

FIG. 14 is a perspective view showing the application of the engagement structure for the tool according to the preferred embodiment of the present invention.

FIG. 15 is another perspective view showing the application of the engagement structure for the tool according to the preferred embodiment of the present invention.

FIG. 16 is also another perspective view showing the application of the engagement structure for the tool according to the preferred embodiment of the present invention.

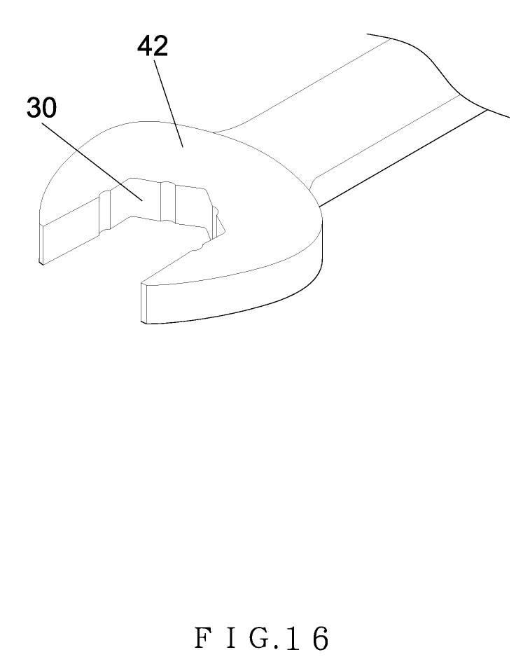

### DETAILED DESCRIPTION OF THE PREFERRED EMBODIMENTS

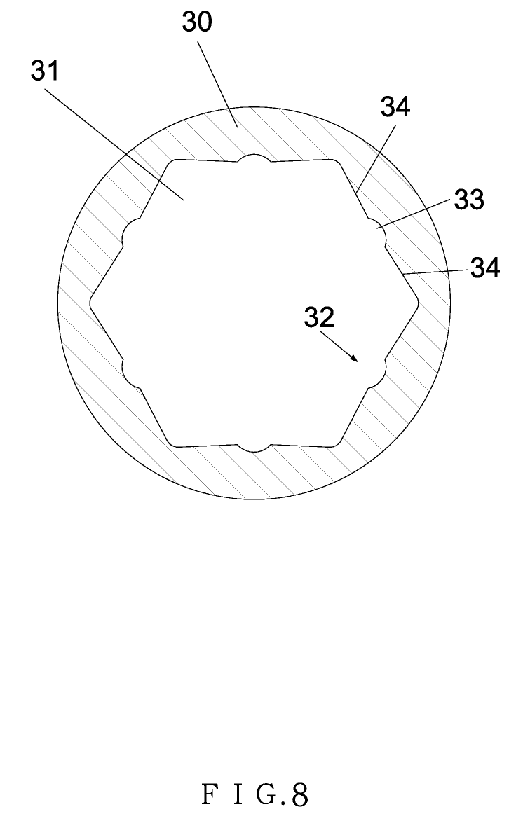

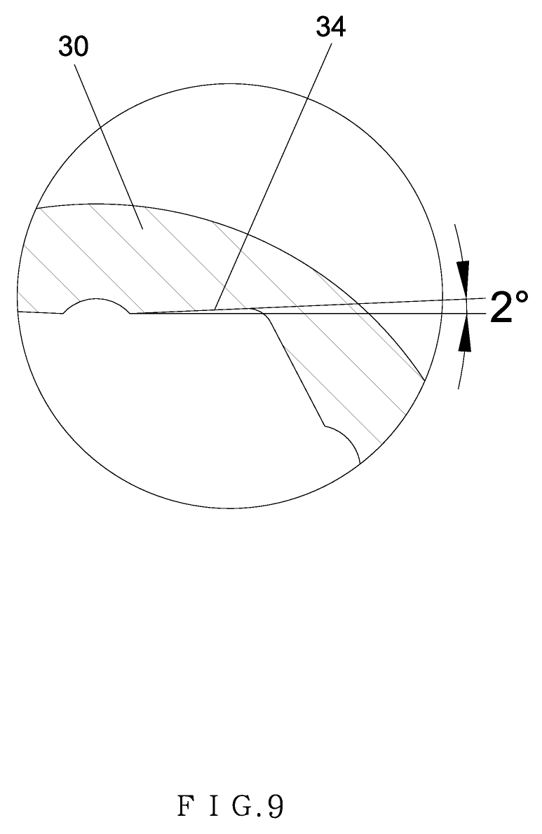

With reference to FIGS. 8 and 9, an engagement structure for a tool according to a preferred embodiment of the present invention comprises a drive member 30 including an accommodation orifice 31 defined in the drive member 30, a hexagonal tooth portion 32 formed around the accommodation orifice 31, and six arcuately concave sections 33 respectively arranged on six sides of the hexagonal tooth portion 32, wherein each of the six arcuately concave sections 33 is arranged on a center of each of the six sides of the hexagonal tooth portion 32. The drive member 30 further includes multiple bevel rims 34, any two spaced of the multiple bevel rims 34 respectively extend from two sides of each arcuately concave sections 33, and any adjacent of the multiple bevel rims 34 connect, wherein an inclined angle each of the multiple bevel rims 34 is 2 degrees.

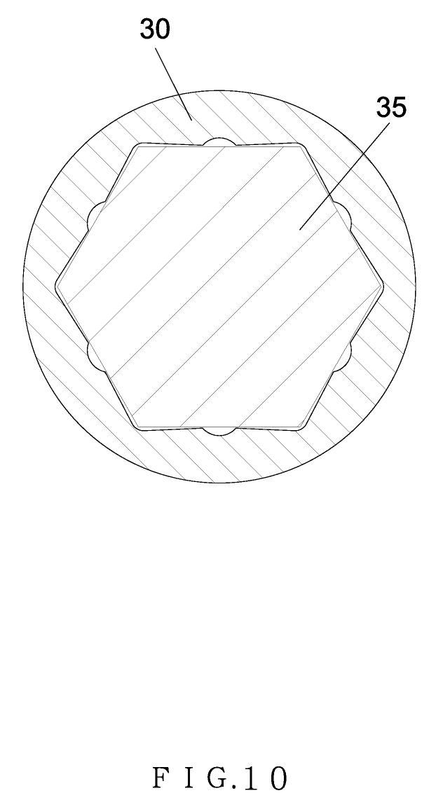

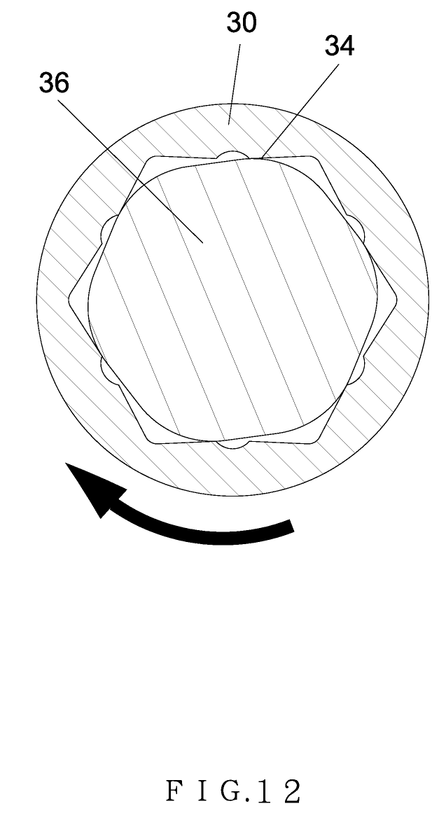

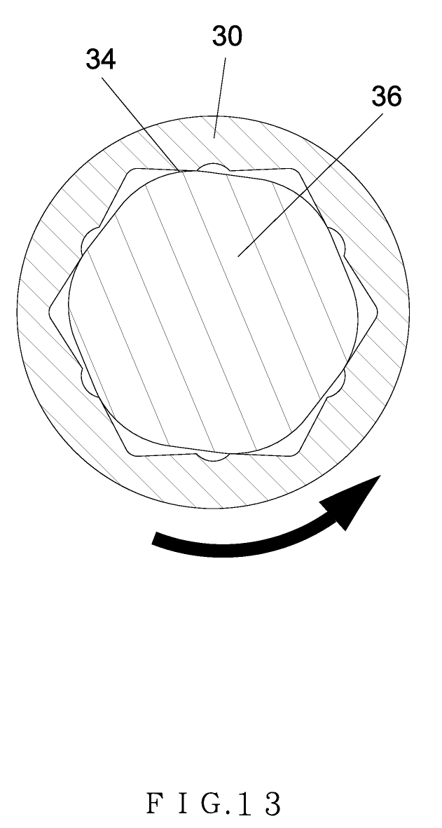

Referring to FIGS. 10-13, the drive member 30 rotates a hexagonal object 35 or a non-hexagonal object 36 clockwise or counterclockwise so as to fix or remove the hexagonal object 35 or the non-hexagonal object 36, wherein the multiple bevel rims 34 of the hexagonal tooth portion 32 engage with and rotate a peripheral side of the hexagonal object 35 or the non-hexagonal object 36 easily.

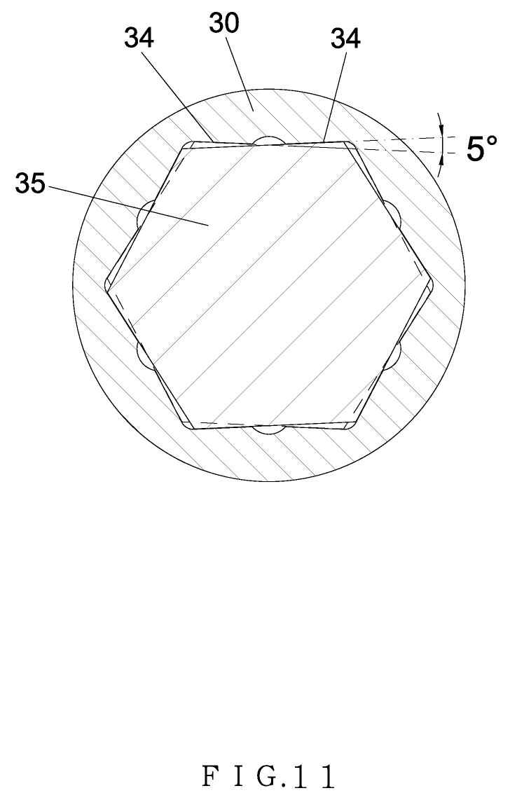

As shown in FIG. 11, an idle angle of the hexagonal tooth portion 32 is equal to 5 degrees when revolving the drive member 30 so as to facilitate operation of the drive member 30 in a limited space. Preferably, an angle between each bevel rim 34 and a plane is within 2 degrees to 5 degrees.

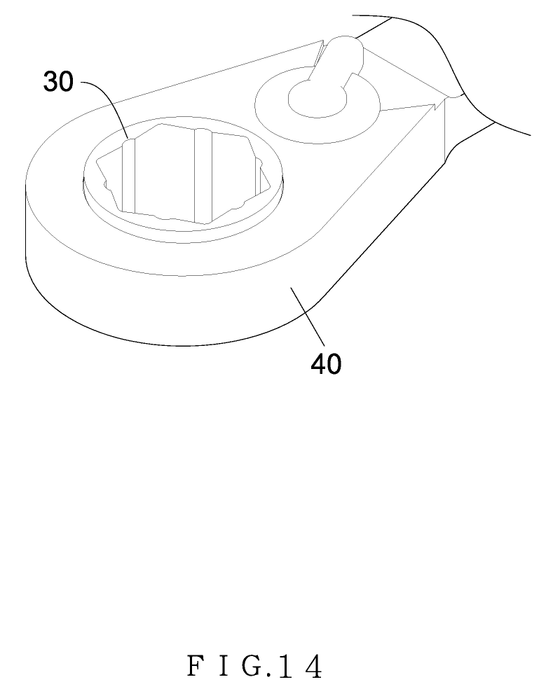

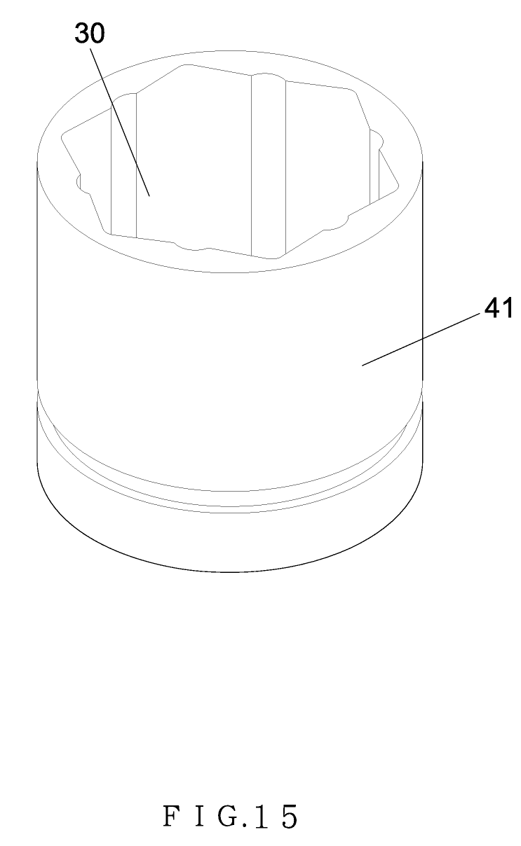

As illustrated in FIGS. 14-15, the drive member 30 is applicable for the tool, such as a ratchet wrench 40, a socket 41, or an open end wrench 42.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. An engagement structure for a tool comprising:
a drive member including an accommodation orifice defined in the drive member, a hexagonal tooth portion formed around the accommodation orifice, and six arcuately concave sections respectively arranged on six sides of the hexagonal tooth portion;
wherein each of the six arcuately concave sections is arranged on a center of each of the six sides of the hexagonal tooth portion;
wherein the drive member further includes multiple bevel rims, any two spaced of the multiple bevel rims respectively extend from two sides of each arcuately concave sections, and any adjacent of the multiple bevel rims connect, wherein an inclined angle each of the multiple bevel rims is 2 degrees.

2. The engagement structure for the tool as claimed in claim 1, wherein the multiple bevel rims of the hexagonal tooth portion engage with and rotate a peripheral side of the hexagonal object or the non-hexagonal object.

3. The engagement structure for the tool as claimed in claim 1, wherein an idle angle of the hexagonal tooth portion 32 as revolving the drive member 30 is less than 5 degrees

4. The engagement structure for the tool as claimed in claim 1, wherein the tool is any one of a ratchet wrench, a socket, and an open end wrench.

5. The engagement structure for the tool as claimed in claim 1, wherein an angle between each bevel rim and a plane is within 2 degrees to 5 degrees.
